(19) United States
(12) Patent Application Publication
(10) Pub. No.: US 2016/0075308 A1
(43) Pub. Date: Mar. 17, 2016

(54) DEVICE FOR A SYSTEM FOR CONNECTING A BLADE TO A WINDSCREEN WIPER ARM

(71) Applicant: VALEO SYSTEMES D'ESSUYAGE, Le Mesnil Saint Denis (FR)

(72) Inventors: Guillaume Mouleyre, Saint Genes Champanelle (FR); William Terrasse, Vic Le Comte (FR)

(73) Assignee: VALEO SYSTEMES D'ESSUYAGE, Le Mesnil Saint Denis (FR)

(21) Appl. No.: 14/826,401

(22) Filed: Aug. 14, 2015

(30) Foreign Application Priority Data
Sep. 15, 2014 (FR) 1458648

(51) Int. Cl. B60S 1/40; B60S 1/38

(52) U.S. Cl. CPC B60S 1/4048; B60S 1/3849; B60S 2001/4051

(57) ABSTRACT

A first device for a system for connecting a blade to an arm of a windscreen wiper is disclosed. The first device includes means of articulation configured to interact with complementary means of a second device of the connecting system, in order to define an axis of articulation of the first device in relation to the second device, which is an axis of articulation of the blade in relation to the arm. The first device includes first means of abutment configured to interact with the second device to maintain the first device in relation to the second device in translational movement in the axis of articulation, in a first direction, and second means of abutment configured to interact with the second device to maintain the first device in relation to the second device in translational movement in the axis of articulation, in a second direction counter to the first direction.

### TECHNICAL FIELD

The present invention relates in particular to a device for a system for connecting a blade to a windscreen wiper arm, this device being a connector or an adapter, for example.

### STATE OF THE ART

A motor vehicle is conventionally equipped with windscreen wipers in order to ensure washing of the windscreen and to prevent the driver's view of his environment from being impaired. These windscreen wipers comprise in general a driving arm, performing an angular reciprocating movement, and elongated blades, which are themselves carriers of scraper blades made of an elastic material. These blades rub against the windscreen and remove the water by bringing it outside the driver's field of vision. The blades are executed in the form, either, in a traditional version, of articulated mountings which hold the scraper blade at several discrete locations by imparting to it a bent shape enabling it to conform to the possible curvature of the windscreen, or, in a more recent version referred to as a “flat blade” (for “flat blade”), of a semi-rigid assembly which supports the scraper blade over its entire length thanks to one or a plurality of bending vertebrae permitting the blade to be applied to the windscreen without having to use mountings.

In both solutions, the blade is attached to the driving arm by means of a connecting system including a connector and an adapter. The connector is a component which is attached to the blade and which is in general crimped directly onto the scraper blade or onto the flat blade, whereas the adapter is integral with the arm. The adapter is an intermediate component which permits the attachment and the securing of the connector to the driving arm. It is configured in general in order to be engaged in a head or an end component in the form of a yoke of the driving arm.

Each of these devices (connector and adapter) comprises means of articulation configured in order to interact with complementary means of the other device, in order to define at least one transverse axis of articulation of the devices, which is an axis of articulation of the blade in relation to the arm. In the existing technology, one of the devices, such as the connector, comprises a substantially cylindrical physical axis which defines the axis of articulation and which is received in a housing of complementary form to the other device. The physical axis comprises in general a peg or one or more cylindrical pins engaged in the housing by elastic latching.

The invention proposes an improvement to this technology which is simple, effective and economical.

### DISCLOSURE OF THE INVENTION

The invention proposes for this purpose a first device for a system for connecting a blade to a windscreen wiper arm, this first device being configured in order to be attached to said blade or to said arm and including means of articulation configured in order to interact with complementary means of a second device of the connecting system, in order to define an axis (Y) of articulation of the first device in relation to this second device, which is an axis of articulation of said blade in relation to said arm, said first device being characterized in that it comprises first means of abutment which are configured in order to interact with said second device so as to maintain said first device in relation to said second device in translational movement in said axis of articulation, in a first direction, and second means of abutment which are configured in order to interact with said second device so as to maintain the first device in relation to said second device in translational movement in said axis of articulation, in a second direction counter to the first direction.

The expression “axis of articulation of the blade in relation to the arm” is understood to denote an axis which assures the pivoting of the blade in relation to the arm in the course of the normal wiping of a curved screen. In other words, this axis allows the relative rotation of the blade in relation to the arm, in a plane perpendicular to the windscreen passing through the arm.

The first device according to the invention may comprise one or a plurality of the following characterizing features, taken in isolation or in combination with one other:
said means of articulation are configured in order to be mounted on or in said complementary means by axial displacement in said axis of articulation;
the first device is an adapter configured in order to be attached to said arm or a connector configured in order to be attached to said blade;
a plane that is substantially parallel to said axis of articulation passes through said means of articulation and through said first and second means of abutment;
said first device has an elongated form and in that said plane is substantially parallel to an axis of elongation of said first device;
said means of articulation comprise a cylindrical peg;
said means of articulation are situated at a lower end of said first device;
said means of articulation are connected to the rest of the first device by a web of material extending in said axis of articulation;
the first device is formed in a single piece;
said first and/or second means of abutment project from said first device;
said first and/or second means of abutment project from said means of articulation;
the first and/or second means of abutment comprise at least one fin projecting from said means of articulation, said at least one fin extending in the axis of articulation;
said first and second means of abutment are situated at a distance from said means of articulation and project, for example, from the lateral walls of the first device;
the first device comprises a first lateral wall which comprises said first projecting means of abutment, for example being one or two in number, and a second lateral wall which comprises said second projecting means of abutment, for example being one or two in number.

The present invention also relates to a system for connecting a blade to an arm of a windscreen wiper, this system including two devices, of which one is configured in order to be attached to said blade and the other is configured in order to be attached to said arm, characterized in that a first of the devices is as defined above, and a second of the devices includes means configured in order to interact with said first and second means of abutment, for example by the interaction of their forms.

Advantageously, the first device is an adapter configured in order to be attached to said arm, and said second device is a connector configured in order to be attached to said blade.

The present invention further relates to a blade of a windscreen wiper, characterized in that it comprises a first device or a system as described above.

The invention makes it possible in particular to have a universal blade in terms of its length and to be able to associate the adapter and/or the connector of choice thereto.

### DESCRIPTION OF THE FIGURES

The invention will be better understood, and other details, characterizing features and advantages of the invention will emerge from a perusal of the following description, which is provided by way of non-exhaustive example with reference to the accompanying drawings, in which:

FIG. 1 is a partial schematic view in perspective of a windscreen wiper according to the invention, this windscreen wiper including a blade of a windscreen wiper, a driving arm for the blade, and a system for connecting the blade to the arm,

FIG. 2 is an exploded schematic view in perspective and on a larger scale of the connecting system of the windscreen wiper in FIG. 1,

FIG. 3 is a schematic view in perspective of the adapter of the connecting system of the windscreen wiper in FIG. 1,

FIG. 4 is a schematic view in perspective of the connector of the connecting system of the windscreen wiper in FIG. 1,

FIGS. 5 to 8 are schematic views in perspective of the connecting system of the windscreen wiper in FIG. 1, and depict stages in the installation of this connecting system,

FIG. 9 is a partial schematic view in perspective of a variant embodiment of a system according to the invention for connecting a blade to a windscreen wiper arm,

FIG. 10 is an exploded schematic view in perspective and on a larger scale of the connecting system in FIG. 9,

FIG. 11 is a schematic view in perspective of the connector of the connecting system in FIG. 9,

FIG. 12 is a schematic view from below of the connector of the connecting system in FIG. 9,

FIG. 13 is another schematic view in perspective of the connector of the connecting system in FIG. 9,

FIG. 14 is a schematic view in perspective of the adapter of the connecting system in FIG. 9, and

FIGS. 15 to 18 are schematic views in perspective of the connecting system in FIG. 9, and depict stages in the installation of this connecting system.

### DETAILED DESCRIPTION

It should be noted that the figures reveal the invention in a detailed manner for the purpose of the implementation of the invention, said figures also being suitable, of course, for defining the invention more clearly, if necessary.

In the following description, the designations longitudinal or lateral refer to the orientation of the blade of a windscreen wiper or of the driving arm according to the invention. The longitudinal direction corresponds to the principal axis of the blade or of the arm in which it extends, whereas the lateral orientations correspond to concurrent straight lines, that is to say lines of intersection which cross the longitudinal direction, in particular being perpendicular to the longitudinal axis of the blade or of the arm in its plane of rotation. For the longitudinal directions, the designations external or internal should be understood in relation to the point of securing the blade to the arm, the designation internal corresponding to the area where the arm and a half-blade extend, or in relation to the point of securing the arm to the vehicle. Finally, the directions referred to as upper or lower correspond to orientations that are perpendicular to the plane of rotation of the windscreen wiper blade, the designation lower containing the plane of the windscreen.

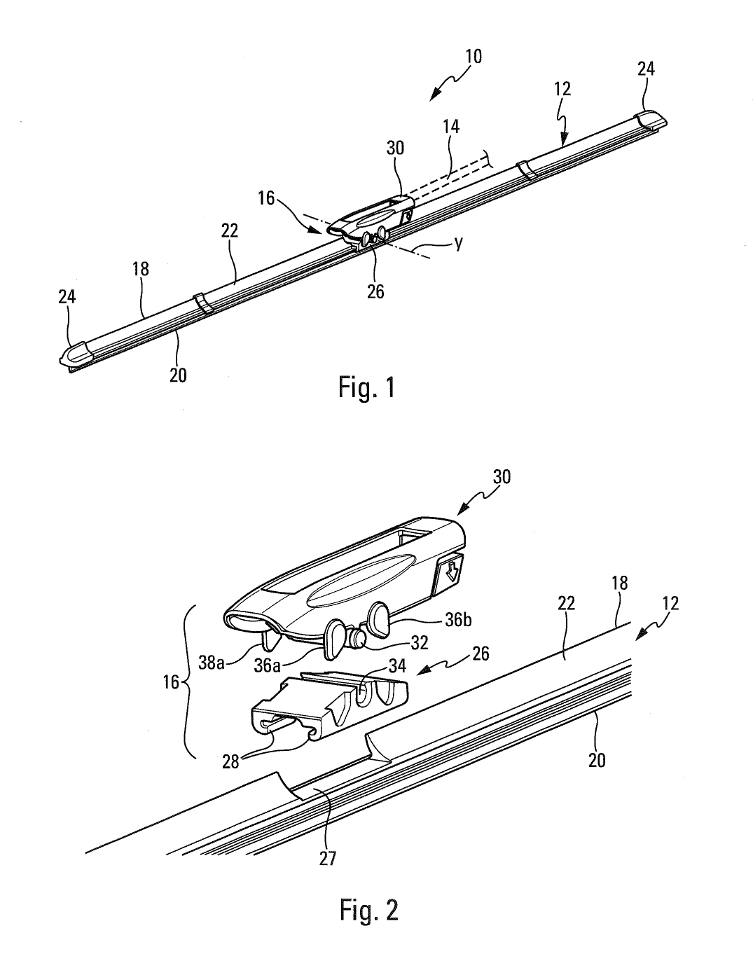

Reference is made initially to FIGS. 1 to 8, which depict a first embodiment of the invention.

FIG. 1 depicts a windscreen wiper 10 in its entirety, this windscreen wiper 10 including a blade 12, an arm 14 (depicted schematically by dashed lines) for driving the blade 12, and a system 16 for connecting the blade 12 to the arm 14.

The arm 14 in this case is a “rod” arm of the kind that is well known to a person skilled in the art, and it is accordingly not described in more detail below. Any other type of arm may naturally be utilized within the scope of the present invention. The arm 14 is intended to be driven by a motor in order to describe an angular reciprocating movement permitting the removal of the water and, where appropriate, of other undesirable elements covering the windscreen.

The blade 12 is preferably of the flat blade type and comprises a longitudinal body 18, a wiper strip 20, in general made of rubber, and at least one vertebra which imparts rigidity to the blade 20 and assists its application to the windscreen.

The body 18 of the blade 12 may include an upper aerodynamic deflector 22 intended to improve the function of the windscreen wiper, the purpose of this deflector 22 being to improve the pressing of the blade onto the windscreen and consequently the aerodynamic performance of the windscreen wiper.

The blade 12 further comprises end fittings 24 or clips for anchoring the blade 20 and the vertebra to the body 18, these end fittings 24 being situated at each of the longitudinal ends of the body 18.

The body 18 of the blade may be composed of two parts which are positioned substantially end-to-end and connected one to the other by an intermediate connector 26 which is part of the connecting system 16. These parts may be independent of one another or linked together by a middle part of the body, defined by a partial central cut-out 27 in the body, as can be seen in FIG. 2.

The connector 26 is inserted between the two parts of the body 18 and may comprise means of connection to these parts. The connector 26 may comprise means for securing it to the one or more vertebrae. It may thus comprise lower claws 28 defining longitudinal grooves for receiving, in general by sliding, longitudinal end parts of the one or more vertebrae, as can be seen in FIG. 2. The connector 26 is accordingly configured in order to be attached to the blade 12.

The connecting system 16 further comprises an adapter 30 which is configured in order to be attached to the arm 14 and which is mounted on the connector 26 in such a way as to retain at least one degree of freedom by pivoting about an axis of articulation Y which is a transverse axis that is substantially perpendicular to the longitudinal axis of the blade 12 (FIG. 1). This degree of freedom allows pivoting of the blade 12 in relation to the arm 14 and in this way permits the blade to follow the curvature of the windscreen in the course of its displacements.

This degree of freedom is achieved thanks to means of articulation of the adapter 30 which are configured in order to interact with complementary means of the connector 26, and vice versa, in order to define said axis of articulation Y.

In the depicted example, the means of articulation comprise a cylindrical peg 32 which is carried by the adapter 30 and which is engaged in a cylindrical housing 34 of the connector 26. The cylindrical peg 32 extends in a transverse direction and defines the axis Y. According to one characterizing feature of the invention, the peg 32 is engaged in the housing 34 by translation in the axis Y, as described in more detail below.

According to another characterizing feature of the invention, the means of articulation are associated with means of abutment which limit or prevent displacements of the adapter 30 in relation to the connector 26, in the axis Y, after their installation.

In the depicted example, it is the adapter 30 which carries these means of abutment, which comprise first projecting means 36a, 36b of abutment which are configured in order to interact with the connector so as to maintain the adapter in relation to the connector 26 in translational movement in the axis Y, in a first direction, and second projecting means 38a of abutment which are configured in order to interact with the connector so as to maintain the adapter in relation to the connector in translational movement in the axis Y, in a second direction counter to the first direction.

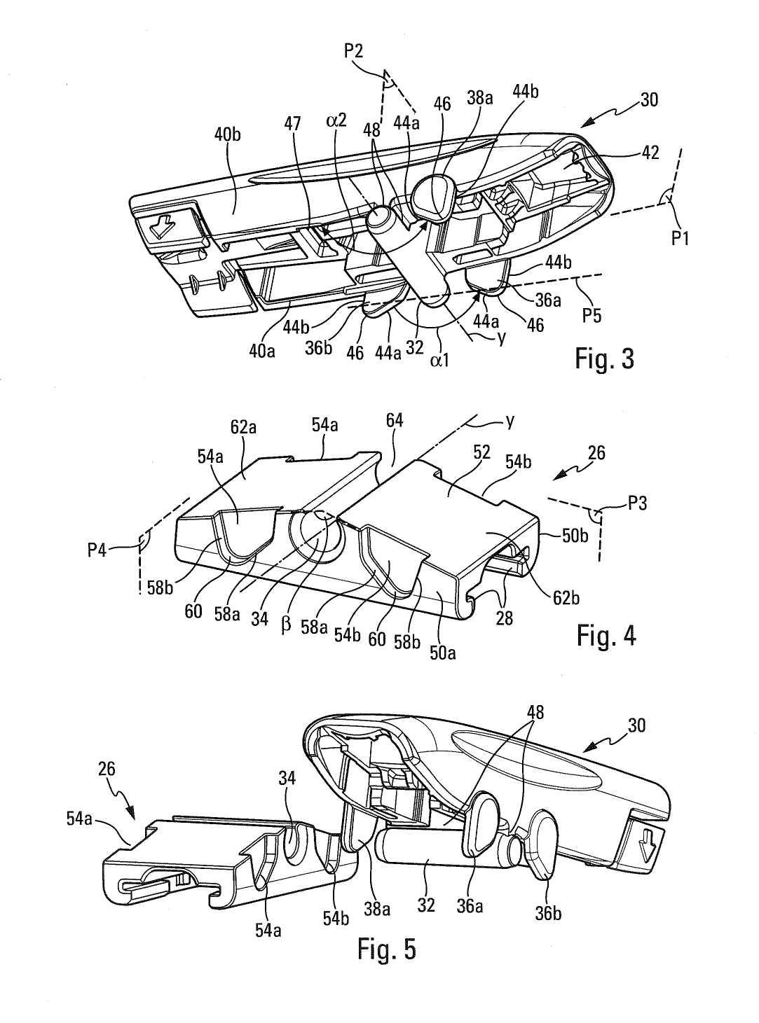

As can be appreciated more clearly in FIG. 3, the adapter 30 has an elongated general form in the longitudinal direction of the blade 12. It comprises two lateral walls 40a, 40b that are substantially parallel to and at a distance from one another. These walls 40a, 40b are connected together at their upper ends by a transverse wall 42 that is substantially perpendicular to the walls 40a, 40b. The walls 40a, 40b, 42 in this case have an elongated form in the longitudinal direction.

The walls 40a, 40b carry legs 36a, 36b, 38a which form the aforementioned first and second means of abutment. The wall 40a carries a pair of legs 36a, 36b, whereas the wall 40b carries a single leg 38a. The legs in this case are three in number, however. The legs 36a and 38a are positioned in a symmetrical manner in relation to a median longitudinal plane P1 of the adapter 30, and the legs 36a and 36b are positioned in a symmetrical manner in relation to a median transverse plane P2 of the adapter 30. In addition, the legs 36a, 38a have symmetrical forms in relation to the plane P1.

The planes P1 and P2 intersect at the axis of articulation Y. The plane P1 in this case is substantially parallel to the walls 40a, 40b, and the plane P2 in this case is substantially perpendicular to these walls.

The legs 36a, 36b of the wall 40a are situated at a longitudinal distance from one another. Each wall 40a, 40b comprises a front or external leg 36a, 38a, and the wall 40b comprises a rear or internal leg 36b. The legs are substantially plane. The legs 36a, 36b of the wall 40a extend substantially in a longitudinal plane that is substantially parallel to this wall. The legs extend at a distance from the axis Y and the peg 32.

The legs 36a, 36b, 38a in this case are formed in a single piece with the adapter 30.

Each leg in this case extends downwards from the lower end of the adapter 30. Each leg comprises a first lower peripheral edge 44a situated to the side of the axis Y and a second lower peripheral edge 44b situated to the side opposite the axis Y (FIGS. 3 and 5). These edges 44a, 44b are substantially rectilinear in this case. The edges 44a of the legs 36a, 36b are flared out or spread downwards one from the other in this case. These edges 44a form between them an angle α1 with a predetermined value, for example in the order of 120° (FIG. 3). The edges 44b are substantially parallel.

As can be appreciated in FIG. 3, as a result of the absence of a rear leg on the wall 40b, this wall 40b has its lower peripheral edge 47 which is free. The angle between this peripheral edge 47 and the edge 44a of the leg 38a of the wall 40b, measured around the axis Y (in the plane of the wall 40b), is denoted α2. This angle α2 has a predetermined value, for example in the order of 150°.

Each leg 36a, 36b, 38a comprises at its lower free end a concave curved peripheral edge 46 which connects the lower ends of the edges 44a, 44b to one another.

The peg 32 extends substantially to a point mid-way between transverse planes parallel to the axis Y and passing respectively via the legs 36a, 38a, and the leg 36b.

The peg 32 is formed in a single piece with the adapter 30 and is connected to the latter by a web of material 48 which extends in the axis Y. As can be appreciated in FIG. 3, the peg 32 is situated at the lower end of the adapter 30, the web 48 extending in a transverse plane passing through the axis Y.

As can also be appreciated in FIG. 3, the legs 36a, 36b, 38a are cut by a longitudinal plane P5 parallel to the axis Y and passing via the cylindrical peg 32, for example in its axis Y.

The connector 26, as can be appreciated more clearly in FIG. 4, has an elongated general form in the longitudinal direction of the blade 12. It comprises two lateral walls 50a, 50b that are substantially parallel to and at a distance from one another. These walls 50a, 50b are connected together at their upper ends by an upper wall 52 that is substantially perpendicular to the walls 50a, 50b. The lower ends of the walls 50a, 50b carry or form the aforementioned claws 28. The walls 50a, 50b, 52 in this case have an elongated form in the longitudinal direction.

The connector 26 comprises bearing surfaces and/or abutment surfaces for the legs 36a, 36b, 38a of the adapter 30, which in this case in particular are formed by the bases of indentations 54a, 54b provided on the connector.

The indentations 54a, 54b are formed in the walls 50a, 50b, and in particular on their external surfaces. Each wall 50a, 50b comprises a pair of indentations 54a, 54b. The connector 26 thus comprises two pairs of indentations, that is to say four indentations. The indentations are positioned in a symmetrical manner in relation to a median longitudinal plane P3 of the connector 26, as well as in relation to a median transverse plane P4 of the connector. In addition, the indentations 54a, 54b have symmetrical forms in relation to the plane P3.

The planes P3 and P4 intersect at the axis of articulation Y (defined by the housing 34). The plane P3 in this case is substantially parallel to the walls 50a, 50b, and the plane P4 in this case is substantially perpendicular to these walls. The planes P1 and P3 coincide when the connector 26 and the adapter 30 are mounted one on top of the other. The planes P2 and P4 may coincide when the connector 26 and the adapter 30 are mounted one on top of the other.

The indentations 54a, 54b are situated at a longitudinal distance from one another. Each wall 50a, 50b comprises a front or external indentation 54a and a rear or internal indentation 54b. The indentations include substantially flat bases. The indentations 54a, 54b of the same wall 50a, 50b extend substantially in a longitudinal plane substantially parallel to this wall.

Each indentation comprises a first lower peripheral edge 58a situated to the side of the housing 34 and a second lower peripheral edge 58b situated to the side opposite the housing 34 (FIG. 4). These edges 58a, 58b are substantially rectilinear in this case. The edges 58a of the indentations 54a, 54b are flared out or spread downwards one from the other in this case. These edges 58a form between them an angle β with a predetermined value, for example in the order of 120°. The edges 44b are substantially parallel. The indentations 54a, 54b may have forms that are substantially complementary to those of the legs 36a, 36b, 36a with which they are associated.

Each indentation 54a, 54b comprises at its lower free end a concave curved peripheral edge 60 which connects the lower ends of the edges 58a, 58b to each other.

The housing 34 extends substantially to a point mid-way between transverse planes parallel to the axis Y and passing respectively via the indentations 54a, and the indentations 54b.

The housing 34 in this case is situated at the upper end of the connector 26. The upper transverse wall 52 of the connector 26 in this case is in the form of a dihedron and comprises two inclined plane faces 62a, 62b, being respectively front (or external) and rear (or internal) faces. The housing 34 extends to the junction area of the faces 62a, 62b and opens into this area. The housing thus comprises a longitudinal opening 64 which extends at the junction area of the faces 62a, 62b, or in other words at the edge of the dihedron.

As can also be appreciated in FIG. 4, the indentations 54a, 54b are cut by a longitudinal plane P5 parallel to the axis Y and passing through the housing 34, for example at its longitudinal axis.

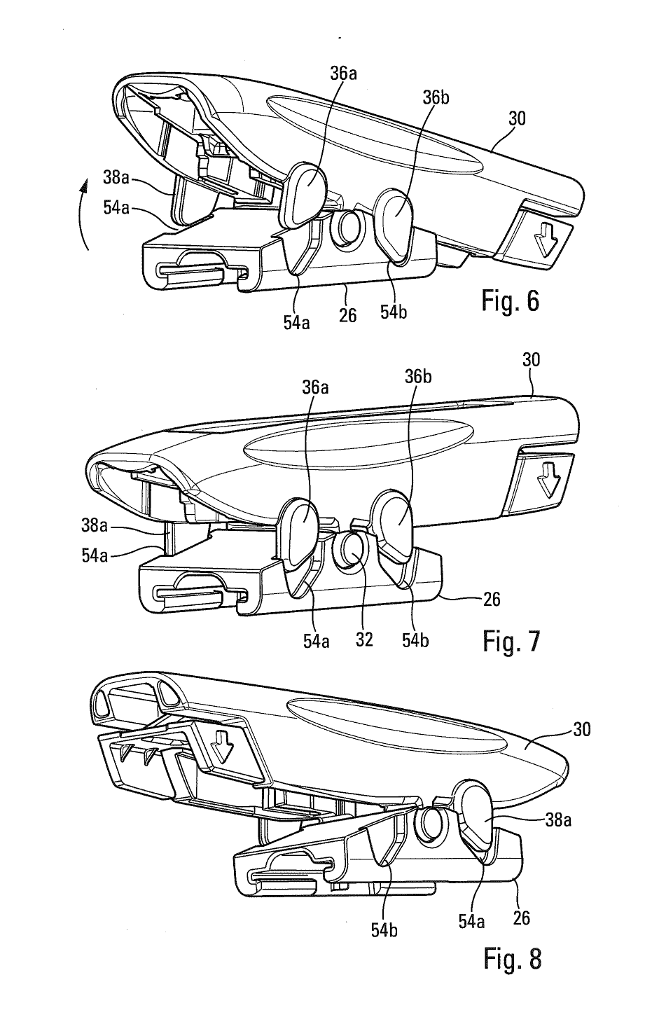

The faces 62a, 62b form between them an angler, with a predetermined value which is in the order of 210°, for example. α1, α2 and β are determined in order, on the one hand, to allow the installation of the peg 32 in the housing 34 by translation in the axis Y and, on the other hand, to ensure that the translational movement of the connector 26 and of the adapter 30 is prevented when they are in the operating position. The angle α2 must be greater than or equal to the angle β in order to allow this translation, as can be clearly appreciated in FIG. 6. It is necessary, furthermore, for the angle α1 to be smaller than the angle β in order to ensure the aforementioned prevention of translational movement, as can be appreciated in FIG. 7.

As can also be appreciated in the drawings, the indentations 54a, 54b have depths (or transverse dimensions, in the axis Y) that are similar to the thicknesses of the legs 36a, 38a, 36b.

The connector 26 is formed in a single piece.

FIGS. 5 to 8 depict stages in the installation of the connecting system 16 according to the invention. The adapter 30 is attached to the arm 14, and the connector 26 is attached to the blade 12. The blade 12 is positioned in relation to the arm 14 in such a way that the connector 26 is positioned in relation to the adapter 30, as depicted in FIG. 5. In this position, the longitudinal axes of the peg 32 and of the housing 34 are in alignment, and the longitudinal axes of the adapter and of the connector are inclined in such a way that the plane parallel to the axis Y and passing through the edges of the legs 36a, 36a passes substantially at the face 62a of the connector or slightly above the latter. The plane parallel to the axis Y and passing through the edge of the leg 36b then passes substantially at the face 62b of the connector or slightly above the latter. The connector is then displaced together with the blade in translational movement in the axis Y until the peg 32 engages in the housing 34 and until the rear leg 36b comes into bearing contact with the base of the rear indentation 54b, as can be appreciated in FIG. 6. The outer ends of the adapter and of the connector are then moved closer together by pivoting, as indicated by the arrow in FIG. 6, in such a way that the external legs 36a, 36a engage in the external indentations 54a, 54b. This ultimately results in the operating position of the windscreen wiper depicted in FIGS. 7 and 8, in which the legs are all engaged in their respective indentations and are able to interact by abutment with the bases of the latter in order to limit or prevent displacements of the connector in relation to the adapter, and accordingly of the blade in relation to the connector, in the axis Y. The installation of the connecting system 16 is then complete, the connector 26 and the blade 12 being able to pivot in relation to the adapter 30 and to the arm 14, about the axis Y. In the course of this pivoting, the legs interact by sliding with the bases of the indentations in order to guide the displacements of the connector in relation to the adapter. The operation of installing the connecting system 16 is performed preferably by the angular orientation of the adapter 30 into a position which will never be encountered during the operation of the blade 12 on the vehicle. The assembly or the disassembly of the connector 26 and of the adapter 30 is accordingly not possible during operation. It will be appreciated, furthermore, that the installation of the adapter on the connector may take place from any side of the connector.

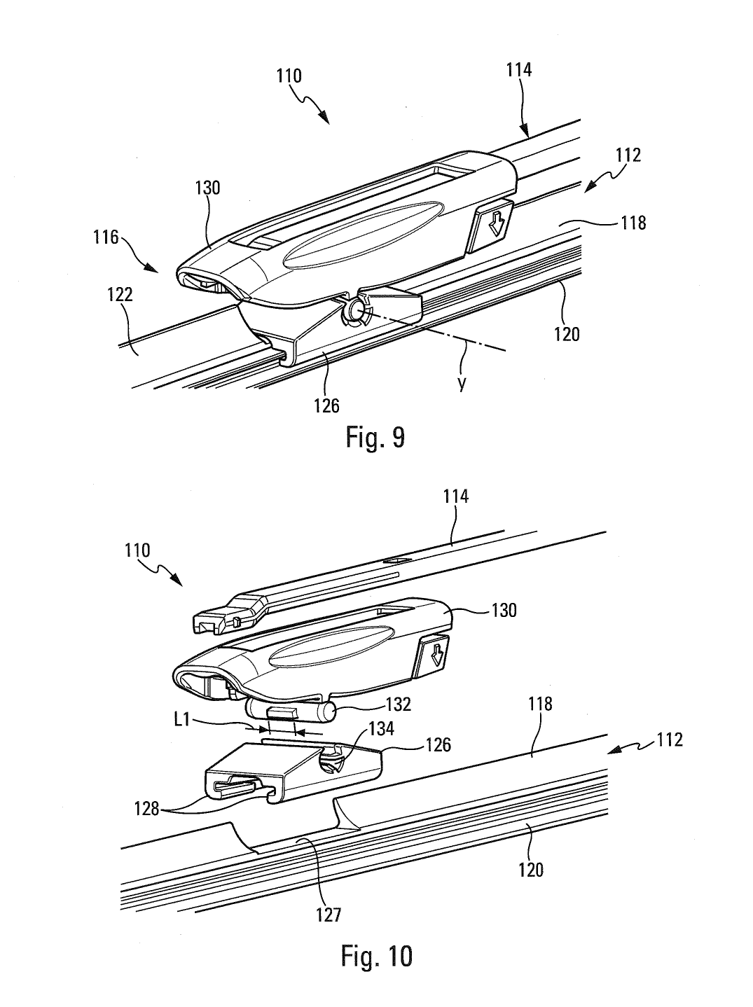

Reference should now be made to FIGS. 9 to 18, which depict a variant embodiment of the invention.

FIG. 9 depicts a windscreen wiper 110 in its entirely, this windscreen wiper 110 including a blade 112, a driving arm 114 for the blade 112, and a system 116 for connecting the blade 112 to the arm 114.

The arm 114 in this case is a “rod” arm, which is well known to a person skilled in the art, and which is accordingly not described in more detail below. Any other type of arm may naturally be utilized within the scope of the present invention. The arm 114 is intended to be driven by a motor in order to describe an angular reciprocating movement permitting the removal of the water and, where appropriate, other undesirable elements covering the windscreen.

The blade 112 is preferably of the flat blade type and comprises a longitudinal body 118, a wiper strip 120, in general made of rubber, and at least one vertebra which imparts rigidity to the blade 120 and assists its application to the windscreen.

The body 118 of the blade 112 may include an upper aerodynamic deflector 122 intended to improve the function of the windscreen wiper, the purpose of this deflector 122 being to improve the pressing of the blade onto the windscreen and consequently the aerodynamic performance of the windscreen wiper.

The blade 112 further comprises end fittings or clips (not illustrated here) for anchoring the blade 120 and the vertebra to the body 118, these end fittings being situated at each of the longitudinal ends of the body 118.

The body 118 of the blade may be composed of two parts which are positioned substantially end-to-end and are connected one to the other by an intermediate connector 126 which is part of the connecting system 116. These parts may be independent of one another or linked together by a median part of the body, defined by a partial central cut-out 127 in the body, as can be seen in FIG. 10.

The connector 126 is inserted between the two parts of the body 118 and may comprise means of connection to these parts. The connector 126 may comprise means for securing to the one or more vertebrae. It may thus comprise lower claws 128 defining longitudinal grooves for receiving, in general by sliding, parts of the longitudinal end of the one or more vertebrae, as can be seen in FIG. 10. The connector 126 is accordingly configured in order to be attached to blade 112.

The connecting system 116 further comprises an adapter 130 which is configured in order to be attached to the arm 114 and which is mounted on the connector 126 in such a way as to retain at least one degree of freedom by pivoting about an axis of articulation Y, which is a transverse axis that is substantially perpendicular to the longitudinal axis of the blade 112. This degree of freedom allows pivoting of the blade 112 in relation to the arm 114 and thus permits the blade to follow the curvature of the windscreen in the course of its displacements.

This degree of freedom is achieved thanks to means of articulation of the adapter 130 which are configured in order to interact with complementary means of the connector 126, and vice versa, in order to define said axis of articulation Y.

In the depicted example, the means of articulation comprise a cylindrical peg 132 which is carried by the adapter 130 and which is engaged in a cylindrical housing 134 of the connector 126. The cylindrical peg 132 extends in a transverse direction and defines the axis Y. According to one characterizing feature of the invention, the peg 132 is engaged in the housing 134 by translation in the axis Y, as described in more detail below.

According to another characterizing feature of the invention, the means of articulation are associated with means of abutment which limit or prevent displacements of the adapter 130 in relation to the connector 126, in the axis Y, after their installation.

In the depicted example, it is the peg 132 of the adapter 130 which caries these means of abutment, which comprise projecting means 136 of abutment which are configured in order to interact with the connector so as to maintain the adapter in relation to the connector 126 in translational movement in the axis Y.

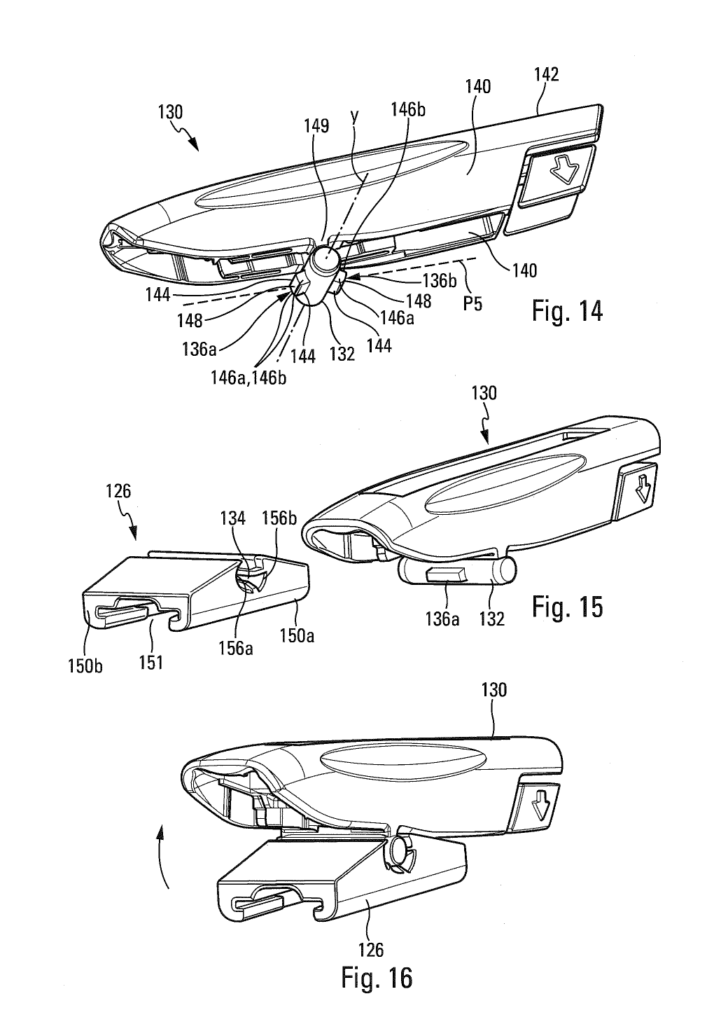

As can be appreciated more clearly in FIG. 14, the adapter 130 has an elongated general form in the longitudinal direction of the blade 112. It comprises two lateral walls 140 that are substantially parallel to and at a distance from one another. These walls 140 are connected to one another at their upper ends by a transverse wall 142 that is substantially perpendicular to the walls 140. The walls 140, 142 in this case have an elongated form in the longitudinal direction.

The peg 132 carries fins 136a, 136b which form the aforementioned means of abutment. The fins in this case are two in number. They each have an elongated rectilinear form in the axis Y. They are situated substantially at the centre of the peg, in its longitudinal direction. They have a length L1 that is much lower than that of the peg 132, such that their longitudinal ends are at a distance from those of the peg (FIG. 10).

Each fin 136a, 136b has a parallelepipedic general form and comprises two lateral longitudinal faces 144, two end faces 146a, 146b and an upper longitudinal face 148. The faces 144 are substantially parallel. The faces 146a, 146b are substantially parallel. These faces 146a, 146b are bearing surfaces, as described in more detail below. The faces 146a of the fins extend in the same plane perpendicular to the axis Y, and their faces 146b extend in another same plane perpendicular to the axis Y.

The fins have substantially radial positions and orientations in relation to the axis Y. A first fin 136a extends towards the front and downwards, and a second fin 136 extends towards the rear and downwards. They form between them an angle α in the order of about 150°.

The adapter 130 in this case is formed in a single piece with the peg 132 and its fins 136a, 136b.

The peg 132 in this case is connected to the rest of the adapter by a web of material 149 which extends in the axis Y. As can be appreciated in FIG. 14, the peg 132 is situated at the lower end of the adapter 130, the web 149 extending in a transverse plane passing through the axis Y.

As can also be appreciated in FIG. 14, the fins 136a, 136b are traversed by a longitudinal plane parallel to the axis Y and passing through the cylindrical peg 132, for example in its axis Y.

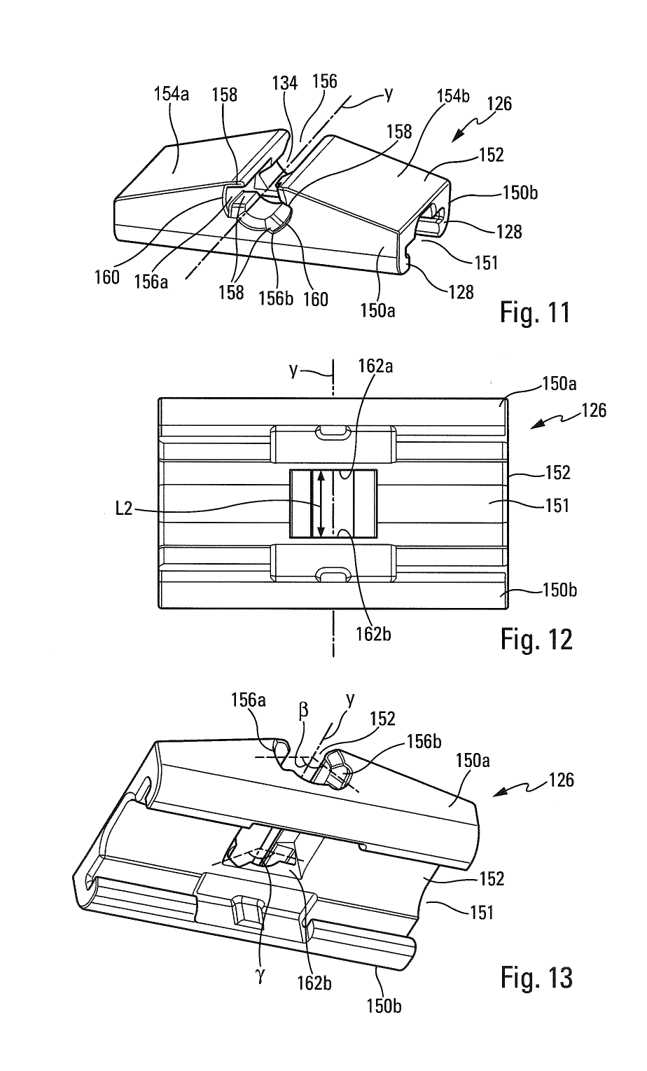

The connector 126, which can be appreciated more clearly in FIGS. 11 to 13, has an elongated general form in the longitudinal direction of the blade 112. It comprises two lateral walls 150a, 150b that are substantially parallel to and at a distance from one another in order to define a longitudinal space 151 between them. These walls 150a, 150b are connected to one another at their upper ends by an upper wall 152 that is substantially perpendicular to the walls 150a, 150b. The lower ends of the walls 150a, 150b carry or form the aforementioned claws 128. The walls 150a, 150b, 152 in this case have an elongated form in the longitudinal direction.

The upper wall 152 of the connector 126 in this case is in the form of a dihedron and comprises two inclined plane faces 154a, 154b, being respectively front (or external) and rear (or internal) faces.

The housing 134 in this case is situated at the upper end of the connector 126. The housing 134 extends into the junction area of the faces 154a, 154b and opens into this area. The housing 134 thus comprises a longitudinal opening 156 which extends at the junction area of the faces 154a, 154b, or in other words at the edge of the dihedron.

The housing 134 extends for the whole of the transverse dimension of the connector 126 and passes through the aforementioned space 151.

The walls 150a, 150b of the connector 126 comprise notches 156a, 156b for the passage of the fins 136a, 136b.

The notches 156a, 156b are formed in the walls 150a, 150b, and open into the cylindrical housing 134. Each wall 150a, 150b comprises a pair of notches 156a, 156b. The connector 126 thus comprises two pairs of notches, that is to say four notches. The notches in this case are not positioned in a symmetrical manner in relation to a median longitudinal plane P3 of the connector 126. The plane P3 in this case is substantially parallel to the walls 150a, 150b. The planes P1 and P3 coincide when the connector 126 and the adapter 130 are mounted one on top of the other.

The notches 156a, 156b are situated at a longitudinal distance from one another. Each wall 150a, 150b comprises a front or external notch 156a and a rear or internal notch 156b. The notches of the same wall have forms and positions permitting the passage of the fins 136a, 136b of the peg 132.

Each notch 156a, 156b comprises two lateral longitudinal faces 158 and one longitudinal base face 160. It does not comprise any longitudinal end faces, since it opens on the one hand onto the external face of the wall 150a, 150b and onto the internal face of this wall, that is to say into the space 151.

The faces 158 of the notch 156a of a wall 150a, 150b are not (all) coplanar with the faces 158 of the notch 156a of the other wall 150b, 150a.

The notches have substantially radial positions and orientations in relation to the axis Y of the housing 134. A first fin 136a in the wall 150a extends towards the front, and a second fin 136b extends towards the rear and downwards. They form between them an angle β in the order of about 150°, which is equal to the aforementioned angle α. A first fin 136a in the wall 150b extends towards the front and downwards, and a second fin 136b extends towards the rear. They form between them an angle γ in the order of about 150°, which is equal to the aforementioned angle α. As can be appreciated in the drawings, the notches in the wall 150a are offset angularly about the axis Y in relation to those of the other wall 150b. In other words, they are not symmetrical in relation to the plane P3 as indicated in the foregoing.

The notches in this case have forms which are complementary to those of the fins.

As can be appreciated in the drawings, the notches 156a, 156b are cut by a longitudinal plane parallel to the axis Y and passing through the housing 134, for example in its longitudinal axis.

The connector 126 comprises bearing surfaces and/or abutment surfaces for the fins 136a, 136b of the adapter 130, which in this case are formed by the internal lateral faces 162a, 162b of the walls 150a, 150b. In other words, the end faces 146a, 146b of the fins are intended to interact by abutment with the internal faces 162a, 162b of the walls 150a, 150b in order to limit or prevent the unwanted translational displacements of the connector 126 in relation to the adapter 130, in the axis Y. The aforementioned notches open into the space 151 on these faces 162a, 162b.

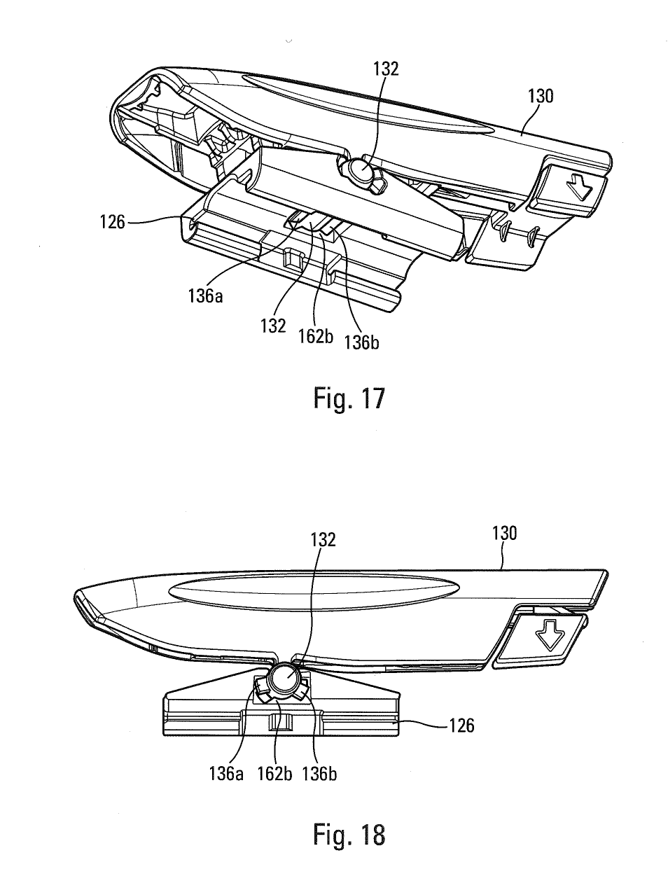

The faces 162a, 162b are situated at a distance L2 from one another. This distance being greater than or equal to the length L1 of the fins 136a, 136b in such a way that the latter may be received between these faces in the operating position (FIGS. 17-18). The faces 162a, 162b are substantially parallel.

The connector 126 is formed in a single piece.

FIGS. 15 to 18 depict stages in the installation of the connecting system 116 according to the invention. The adapter 130 is attached to the arm 114, and the connector 126 is attached to the blade 112. The blade 112 is positioned in relation to the arm 114 in such a way that the connector 126 is positioned in relation to the adapter 130, as depicted in FIG. 15. In this position, the longitudinal axes of the peg 132 and of the housing 134 are in alignment, and the longitudinal axes of the adapter and of the connector are inclined in such a way that the fins 136a, 136b are in alignment in the axis Y with the notches 156a, 156b (of the wall 150a in this case), through which they must pass. The connector is then displaced together with the blade in translational movement in the axis Y until the peg 132 engages in the housing 134 and until the fins 136a, 136b pass through the notches in order to enter the space 151 of the connector 126, as can be seen in FIG. 16. The fins are then present between the faces 162a, 162b of the connector 126. The outer ends of the adapter and of the connector are then moved closer together by pivoting, as indicated by the arrow in FIG. 16, in such a way that the fins are no longer in alignment in the axis Y with the notches of the wall 150a (FIGS. 17 and 18). In this operating position, the fins are also no longer in alignment in the axis Y with the notches of the other wall 150b. The fins may then interact by abutment with the faces 162a, 162b in order to limit or prevent displacements of the connector in relation to the adapter, and consequently of the blade in relation to the connector, in the axis Y. The installation of the connecting system 116 is now complete, the connector 126 and the blade 112 being able to pivot in relation to the adapter 130 and the arm 114, about the axis Y. In the course of this pivoting, the fins interact by sliding by means of their faces 146a, 146b with the faces 162a, 162b of the indentations in order to guide the displacements of the connector in relation to the adapter. The operation of installing the connecting system 116 is performed preferably by the angular orientation of the adapter 130 into a position which will never be encountered during operation of the blade 112 on the vehicle. The assembly or the disassembly of the connector 126 and of the adapter 130 is thus not possible during operation. It will be appreciated, furthermore, that the installation of the adapter on the connector may take place from any side of the connector.

1. A first device for a system for connecting a blade to an arm of a windscreen wiper, wherein the first device is able to be attached to said blade or to said arm, the first device comprising:
means of articulation configured to interact with complementary means of a second device of the connecting system, to define an axis of articulation of the first device in relation to the second device, the axis of articulation being of said blade in relation to said arm;
first means of abutment configured to interact with said second device to maintain said first device in relation to said second device in translational movement in said axis of articulation, in a first direction; and
second means of abutment which are configured to interact with said second device to maintain the first device in relation to said second device in translational movement in said axis of articulation, in a second direction counter to the first direction.

2. The first device according to claim 1, wherein said means of articulation are configured to be mounted on or in said complementary means by axial displacement in said axis of articulation.

3. The first device according to claim 1, said first device being one selected from the group consisting of: an adapter configured to be attached to said arm and a connector configured to be attached to said blade.

4. The first device according to claim 1, in which a plane substantially parallel to said axis of articulation passes through said means of articulation and through said first and second means of abutment.

5. The first device according to claim 4, in which said first device has an elongated form and in that said plane is substantially parallel to an axis of elongation of said first device.

6. The first device according to claim 1, in which said means of articulation comprise a cylindrical peg.

7. The first device according to claim 1, in which said means of articulation are situated at a lower end of said first device.

8. The first device according to claim 1, in which said means of articulation are connected to the rest of said first device by a web of material extending in said axis of articulation.

9. The first device according to claim 1, said first device being formed in a single piece.

10. The first device according to claim 1, in which said first and/or second means of abutment project from said first device.

11. The first device according to claim 1, in which said first and second means of abutment project from said means of articulation.

12. The first device according to claim 11, in which the first and second means of abutment comprise at least one fin projecting from said means of articulation, said at least one fin extending in the axis of articulation.

13. The first device according to claim 1, in which said first and second means of abutment are situated at a distance from said means of articulation and project, for example, from the lateral walls of said first device.

14. The first device according to claim 11, in which said first device comprises a first lateral wall which comprises said first projecting means of abutment and a second lateral wall which comprises said second projecting means of abutment.

15. A system for connecting a blade to an arm of a windscreen wiper, comprising:
two devices of which one device is configured to be attached to said blade, another device is configured to be attached to said arm,
wherein the one of the two devices is as defined according to claim 1, and the another device of the two devices includes means configured to interact with said first and second means of abutment, by the abutment and/or by the interaction of forms of the first and second means of abutment and the another device.

16. The connecting system according to claim 15, in which said first device is an adapter configured to be attached to said arm and said second device is a connector configured to be attached to said blade.

17. A blade of a windscreen wiper, comprising a first device according to claim 1.

18. A blade of a windscreen wiper comprising a connecting system according to claim 15.
